(19) United States
(12) Patent Application Publication
(10) Pub. No.: US 2007/0269312 A1
(43) Pub. Date: Nov. 22, 2007

(54) Assembly of blade units for wind power generation

(75) Inventors: Wei-Chun Hsu, Taoyuan Hsien (TW); Shun-Chen Chang, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/709,196

(22) Filed: Feb. 22, 2007

(30) Foreign Application Priority Data
May 22, 2006 (TW) 095118120

(51) Int. Cl. F03D 11/00

(52) U.S. Cl. 416/186 R

(57) ABSTRACT

A blade unit assembly for wind power generation includes a plurality of blade units connected together. Each blade unit includes a central portion and at least one blade set. A first positioning structure and a second positioning structure, which fit together with each other, are respectively disposed at two opposite end faces of the central portion. The blade set is connected to the central portion. The blade unit assembly is formed by engaging the first positioning structure of one of the blade units with the second positioning structure of another adjacent one of the blade units.

### CROSS REFERENCE TO RELATED APPLICATIONS

This Non-provisional application claims priority under 35 U.S.C. §119(a) on Patent Application No(s). 095118120 filed in Taiwan, Republic of China on May 22, 2006, the entire contents of which are hereby incorporated by reference.

### BACKGROUND OF THE INVENTION

1. Field of Invention

The invention relates to a blade unit and an assembly thereof, and in particular, to an assembly of the blade units for wind power generation.

2. Related Art

In general, environmentally harmful substances such as carbon monoxide and carbon dioxide are released in the power generation process when the power generating apparatus uses materials such as petroleum, sea coal and gas. These material resources are expensive and limited. Green energy, such as solar energy, waterpower or wind power, can be circulated, reproduced and is not harmful to the environment. It has thus become an important developing trend.

Referring to FIG. 1, a conventional impeller 1 of a wind power generating apparatus includes a shaft 11 and two blades 12 disposed helically and symmetrically along the shaft 11. Each impeller 1 can be formed into a monolithic piece and smooth the flow field flowing through the blades 12. However, if any portion of the blade 12 is damaged, the overall impeller 1 has to be replaced. The manufacturing difficulty, replacement cost and difficulty of assembling all increase with the increase of the dimensions of the impeller 1. In addition, the impeller 1 cannot optimize the wind power because the wind comes from all directions, and the impeller 1 may fail to rotate due to the dead angle of the blades 12.

Thus, it is an important subject of the invention to provide a blade unit assembly for wind power generation, which has the advantages in that the cost of replacing the blade can be reduced, the manufacturing and assembling processes can be simplified, no rotating dead angle exists, and the overall efficiency can be enhanced.

### SUMMARY OF THE INVENTION

In view of the foregoing, the invention is to provide a blade unit and an assembly thereof for wind power generation, in which there is no rotating dead angle, the cost of replacing the blade can be reduced, the manufacturing and assembling processes are simplified, and the overall efficiency can be enhanced.

To achieve the above, the invention discloses a blade unit including a central portion and at least one blade set. A first positioning structure and a second positioning structure, which fit together with each other, are respectively disposed at two opposite end faces of the central portion. The blade set is connected to the central portion.

To achieve the above, the invention also discloses a blade unit assembly including a plurality of blade units assembled together. Each blade unit includes a central portion and at least one blade set connected to the central portion. A first positioning structure and a second positioning structure, which fit together with each other, are respectively disposed at two opposite end faces of the central portion. The first positioning structure of the blade unit can combine with the second positioning structure of another adjacent blade unit. The blade unit assembly can be connected to a power generating device to form a wind power generating apparatus.

As mentioned above, the blade unit assembly and the wind power generating apparatus according to the invention are formed by combining a plurality of blade units. Compared with the prior art, when any one of the blade units is damaged, only the damaged blade unit has to be replaced. Thus, the blade unit assembly may be easily manufactured, assembled and maintained, and the cost thereof may be reduced. In addition, disposing a plurality of blade sets of the blade units alternately by an angle between two adjacent blade sets enables wind coming from any direction to rotate the overall blade unit assembly more easily. Thus, no rotating dead angle exists, and the overall efficiency can be enhanced.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional blade assembly for wind power generation;

FIGS. 2a and 2b are schematic illustrations showing a blade unit according to an embodiment of the invention;

FIGS. 3 and 4 are schematic illustrations showing assembling adjacent blade units together according to the embodiment of the invention;

FIGS. 5 to 7 are schematic illustrations showing blade units according to other embodiments of the invention;

FIGS. 8 and 9 are schematic illustrations showing a blade unit assembly according to the embodiment of the invention;

FIG. 10 is a schematic illustration showing another blade unit assembly according to the embodiment of the invention; and

FIG. 11 is a schematic illustration showing a wind power generating apparatus according to the embodiment of the invention.

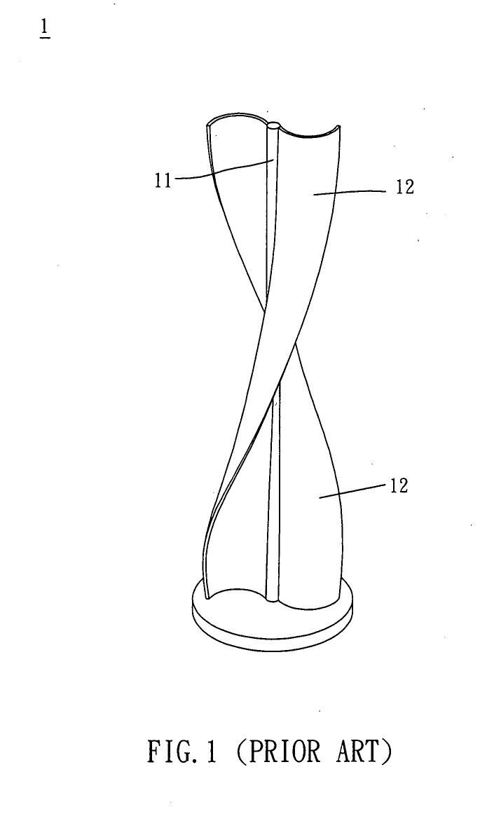

### DETAILED DESCRIPTION OF THE INVENTION

The present invention will be apparent from the following detailed description, which proceeds with reference to the accompanying drawings, wherein the same references relate to the same elements.

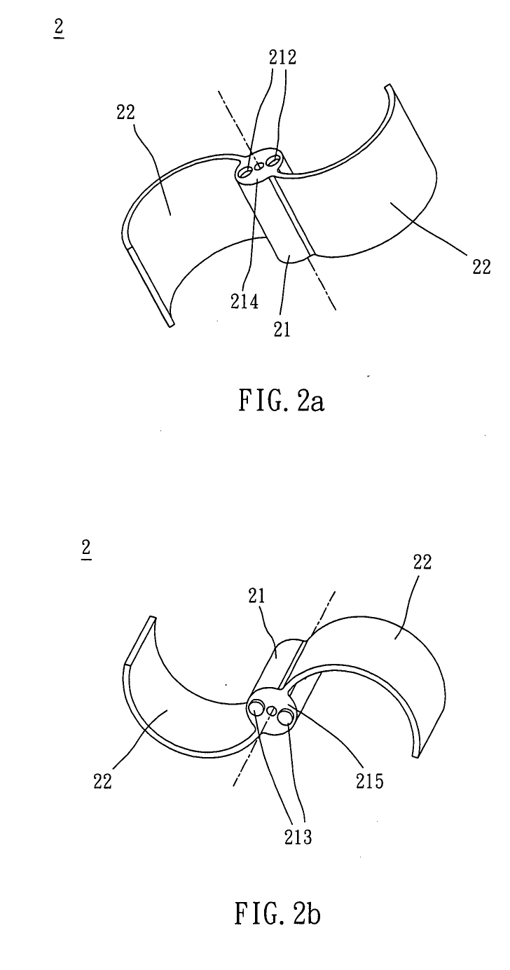

Referring to FIGS. 2a and 2b, a blade unit 2 according to the embodiment of the invention includes a central portion 21 and at least one blade set. The blade set has two blades 22 connected to of the central portion 21. In addition, a first positioning structure 212 and a second positioning structure 213 are disposed on two opposite end faces 214 and 215, respectively. The first and second positioning structures 212, 213 can fit together with each other and have, for example, complementary shapes. The first positioning structure 212 is connected to the second positioning structure 213 of another adjacent blade unit.

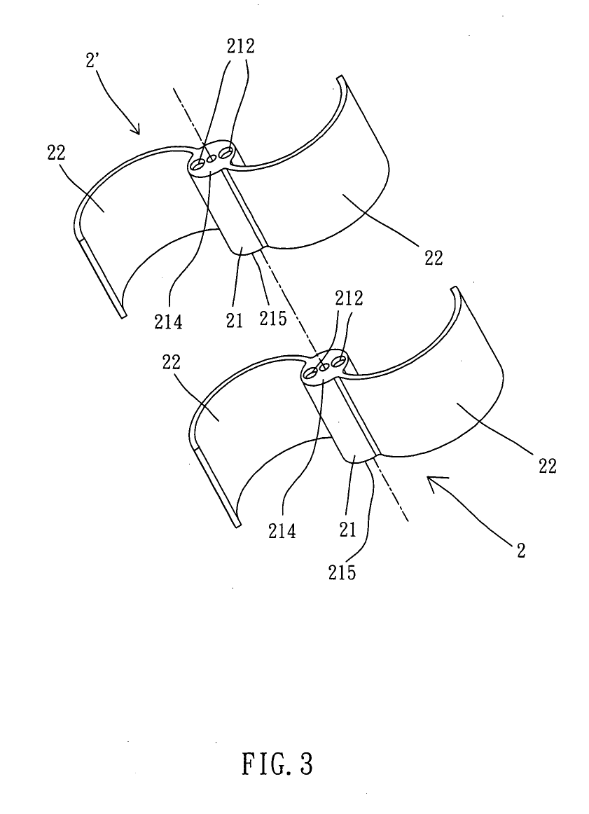

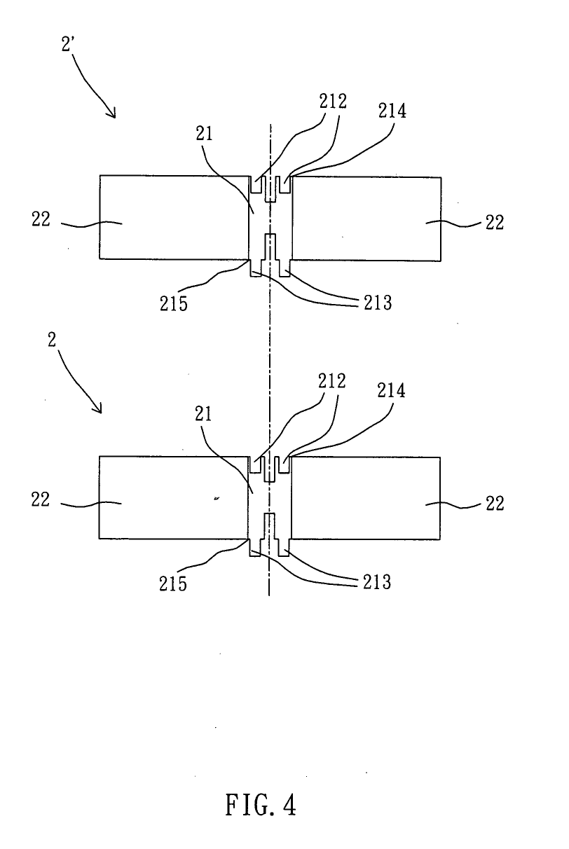

As shown in FIGS. 3 and 4, the blade unit 2 is adjacent to another blade unit 2′. The blade unit 2′ has the same components and functions as those of the blade unit 2, and detailed descriptions thereof will be omitted. The blade units 2 and 2′ are combined with each other through the adjacent first and second positioning structures 212 and 213 by way of engaging, screwing or adhering. In this embodiment, the first positioning structure 212 of the blade unit 2 and the second positioning structure 213 of the blade unit 2′ are combined with each other. The first positioning structure 212 includes at least one concave portion, and the second positioning structure 213 includes at least one convex portion. The concave portion and the convex portion have the same dimension and shape to combine therewith. The complementary concave portion and convex portion enable the blade units 2 and 2′ to be combined with each other.

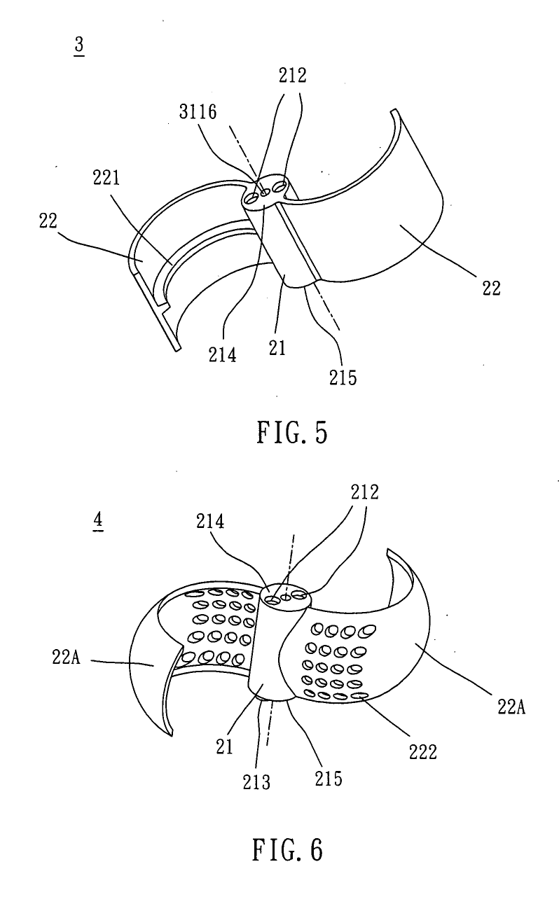

FIGS. 5 to 7 are schematic illustrations showing blade units according to other embodiments of the invention. As shown in FIG. 5, the blades 22 of the blade unit 3 are symmetrically disposed along the central portion 21. In addition, the blade 22 further includes a reinforcing rib 221 connected to the central portion 21 to increase the structural integrity of the blade 22.

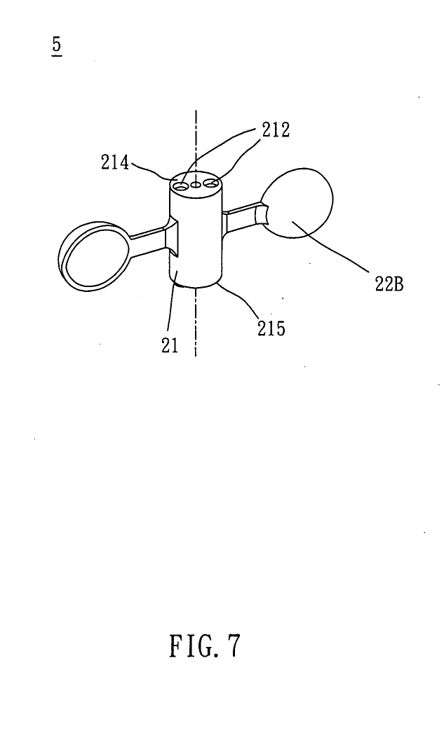

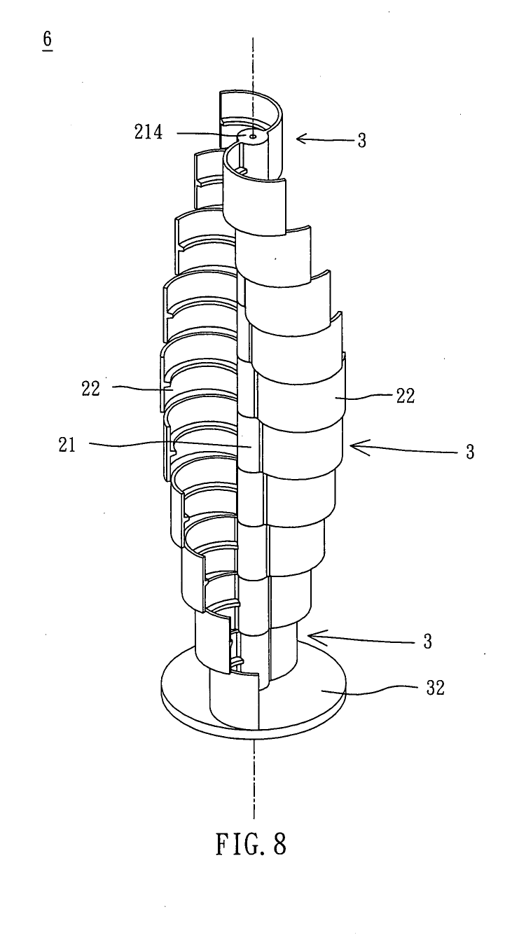

As shown in FIG. 6, the curvature of the blade 22A of the blade unit 4 is different from that of the blade unit 3 shown in FIG. 5, and the blade 22A further includes a plurality of through holes 222 formed near the central portion 21. Because the work generated by the portion of the blade 22A near the central portion 21 is smaller so that the work can be omitted. The through holes 222 disposed near the central portion 21 can reduce the weight of the blade 22. The blade can also be a spoon-like shape, as the blade 22B of the blade unit 5 shown in FIG. 7. In this embodiment, the blade set and the central portion 21 are formed into a monolithic piece, and the blade has a curved, spoon-like, flat or wing-like shape.

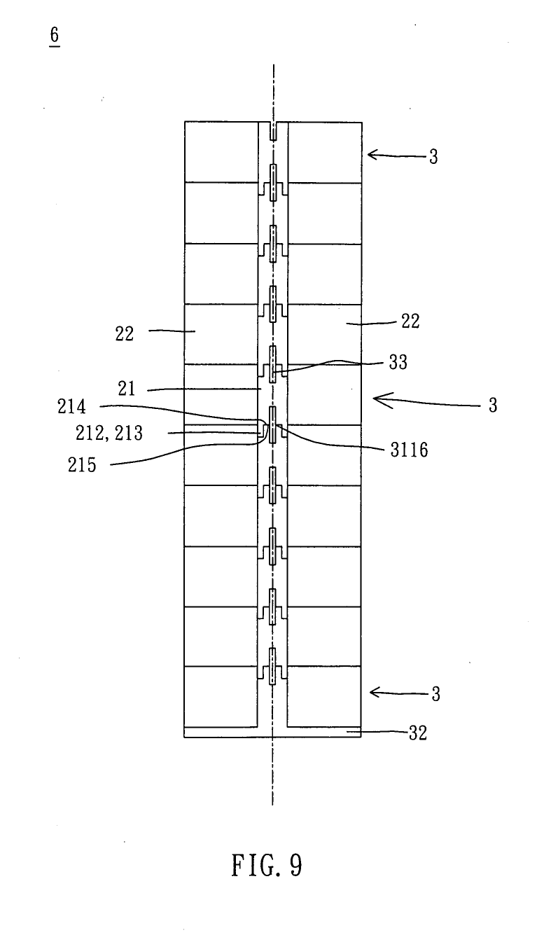

As shown in FIGS. 8 and 9, a blade unit assembly 6 of this embodiment includes a plurality of blade units 3 combined together. The blade unit 3 is the same as the blade unit shown in FIG. 5. Two opposite end faces 214 and 215 of the central portion 21 are respectively formed with a first and second positioning structures 212, 213. The blade set 3 has two blades 22 connected to the central portion 21. It should be noted that the blade unit assembly can also be constituted by a plurality of the blade unit shown in FIG. 3, 6, or 7.

As shown in FIG. 8, after the blade units 3 are combined therewith, an angle is formed between the blades 22 of two adjacent blade sets. These angles between the blades of any two adjacent blade sets can be the same as or different from each other. The angle between the blades 22 of the two adjacent blade sets is formed because the first and second positioning structures 212, 213 of the blade unit 3 are axially projected onto different positions. That is, two adjacent blade units must relatively rotate an angle so that the first positioning structure of one blade unit and the second positioning structure of the adjacent blade unit can be combined with each other. So, when the blade units 3 are being combined therewith, the blades 22 of the two adjacent blade sets naturally form an angle. In this embodiment, because the blade units 3 have the same structure, the same angle is formed between the blades 312 of two adjacent blade sets.

In addition, the blade unit assembly 6 may further include a base 32 connected to the bottommost blade unit 3 by way of engaging, screwing or adhering. It is to be noted that the connection aspect between the blade unit 3 and the base 32 may be different from that between the two adjacent blade units 3 in the middle of the assembly 6. In addition, the bottommost blade unit 31 and the base 32 can be formed as a monolithic piece. Furthermore, the topmost blade unit 31 may also be connected to another device in a connection aspect slightly different from that between the adjacent blade units 31 in the middle of the assembly 6.

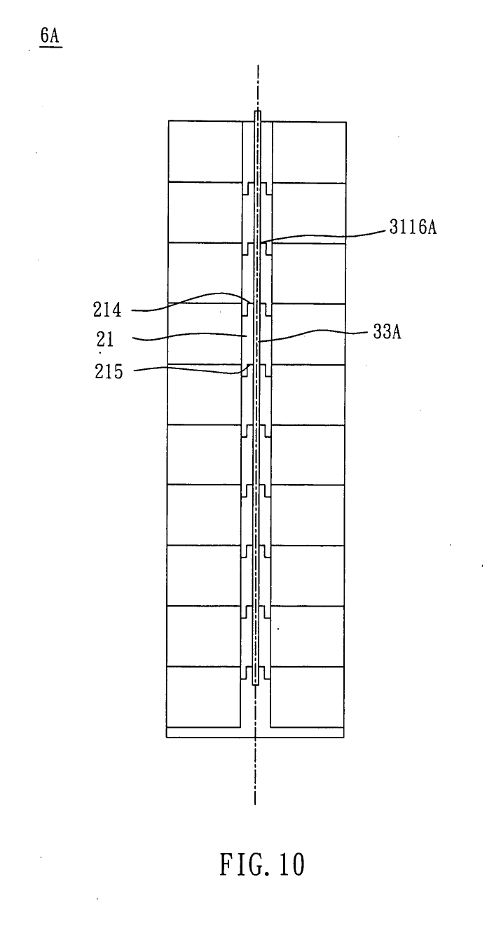

As shown in FIG. 9, the central portion 21 of the blade unit 3 further includes two axial holes 3116 respectively formed on the two opposite end faces 214 and 215, and the blade unit assembly 6 further includes a plurality of shafts 33 passing through two adjacent axial holes 3116 to increase the connection intensity between two adjacent blade units 3. In addition to the above-mentioned aspects, this embodiment may have another aspect, as shown in FIG. 10, in which the central portion 21 of the blade unit assembly 6A is formed with an axial hole 3116A penetrating through the end faces 214 and 215 of each of the central portions 21. In this case, the blade unit assembly 6A further includes a shaft 33A penetrating through the axial holes 3116A to connect all the blade units 3 together.

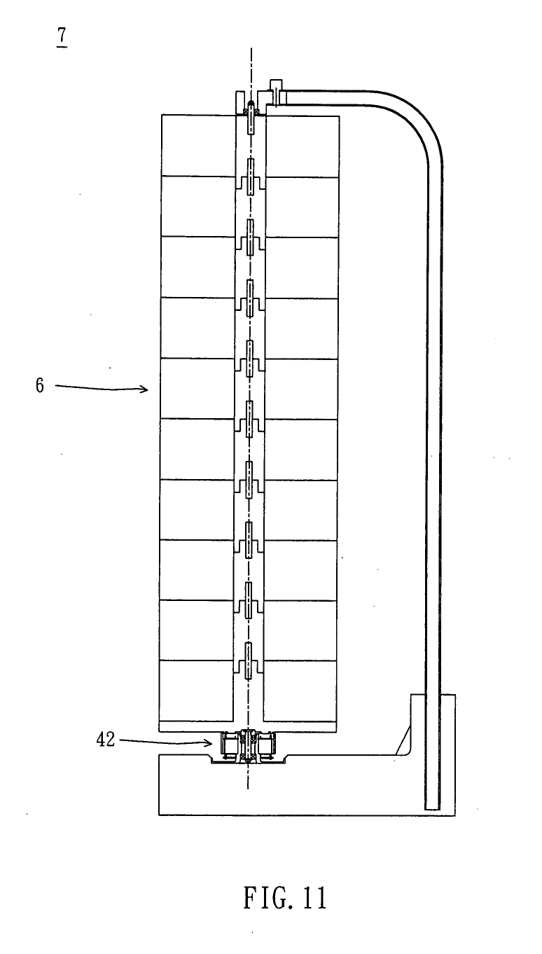

As shown in FIG. 11, the blade unit assembly 6 of the invention can be combined with a power generating device 42 to form a wind power generating apparatus 7. The blade unit assembly 6 has been shown in the FIGS. 8 and 9. The power generating principle is that the kinetic energy of the wind drives the blade unit assembly 41 to rotate, such that the kinetic energy can be converted into mechanical energy, after which the power generating device 42 converts the mechanical energy into the electrical energy. Because the power generating structure and function of the power generating device 42 are not the features of the invention, detailed descriptions thereof will be omitted.

In summary, the blade unit assembly and the wind power generating apparatus according to the invention are formed by connecting a plurality of blade units. Compared with the prior art, when any one of the blade units is damaged, only the damaged blade unit has to be replaced. Thus, the blade unit assembly may be easily manufactured, assembled and maintained, and the cost thereof may be reduced. In addition, disposing a plurality of blade sets of the blade units alternately to form an angle between two adjacent blade sets enables wind coming from any direction to rotate the overall blade unit assembly more easily. Thus, no rotating dead angle exists, and the overall efficiency can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A blade unit for wind power generation, comprising:
a central portion having a first end face and a second end face, wherein the first end face has a first positioning structure, the second end face has a second positioning structure, and the first positioning structure can fit with the second positioning structure; and
at least one blade set connected to the central portion.

2. The blade unit according to claim 1, wherein the central portion comprises at least one axial hole formed on the first end face or the second end face.

3. The blade unit according to claim 1, wherein the first positioning structure comprises at least one convex portion, and the second positioning structure comprises at least one concave portion.

4. The blade unit according to claim 1, wherein the blade set has a plurality of blades disposed symmetrically along the central portion.

5. The blade unit according to claim 4, wherein the blade comprises at least one reinforcing rib connected to the central portion.

6. The blade unit according to claim 4, wherein the blade comprises a plurality of through holes formed near the central portion.

7. The blade unit according to claim 4, wherein the blade has a curved, spoon-like, flat or wing-like shape.

8. The blade unit according to claim 1, wherein the central portion and the blade set are formed as a monolithic piece.

9. A blade unit assembly comprising a plurality of blade units combined together, each of which comprises:
a central portion having at least one positioning structure, wherein the blade units are combined with each other through the at least one positioning structure; and
at least one blade set connected to the central portion.

10. The blade unit assembly according to claim 9, wherein there is an angle formed between two adjacent blade sets.

11. The blade unit assembly according to claim 9, wherein the central portion having a first face and a second face opposite to each other, wherein the first end has a first positioning structure, the second end face has a second positioning structure, and the first positioning structure can fit with the second positioning structure.

12. The blade unit assembly according to claim 9, wherein the central portion comprises at least one axial hole formed on the first end face or the second end face.

13. The blade unit assembly according to claim 12, further comprising at least one shaft inserted into the axial holes of the two adjacent blade units.

14. The blade unit assembly according to claim 12, wherein the axial hole penetrates through the central portion.

15. The blade unit assembly according to claim 14, further comprising a shaft penetrating through the axial holes of all of the blade units.

16. The blade unit assembly according to claim 9, wherein the first and second positioning structures are adjacent to each other and connected to each other by way of engaging, screwing or adhering.

17. The blade unit assembly according to claim 9, wherein the first positioning structure comprises at least one convex portion, and the second positioning structure comprises at least one concave portion.

18. The blade unit assembly according to claim 17, wherein the first positioning structure and the second positioning structure of each of the blade units are axially projected onto different positions.

19. The blade unit assembly according to claim 18, wherein each of the blades has at least one reinforcing rib connected to the central portion.

20. The blade unit assembly according to claim 18, wherein each of the blades has a plurality of through holes formed near the central portion.

21. The blade unit assembly according to claim 9, further comprising a base connected to the last one of the blade units.

22. The blade unit assembly according to claim 21, wherein the base and the last one of the blade units are formed as a monolithic piece.

23. The blade unit assembly according to claim 9, wherein the blade units are combined together in a helical manner.

24. The blade unit assembly according to claim 23, wherein each of the blades has a curved shape, spoon-like shape, a flat shape or a wing-like shape.

25. The blade unit assembly according to claim 9, which is connected to a power generating device to constitute a wind power generating apparatus.
